(19) United States
(12) Patent Application Publication
(10) Pub. No.: US 2018/0017399 A1
(43) Pub. Date: Jan. 18, 2018

(54) SAFETY CHARGING FOR COMPUTER VEHICLE

(71) Applicant: Robert C. Rolnik, Kingwood, TX (US)

(72) Inventor: Robert C. Rolnik, Kingwood, TX (US)

(21) Appl. No.: 15/211,279

(22) Filed: Jul. 15, 2016

(51) Int. Cl. G01C 21/34

(52) U.S. Cl. CPC G01C 21/3469; G01C 21/3484

(57) ABSTRACT

A vehicle data processing system (DPS) is provided for refueling a vehicle. The vehicle DPS may determine a route that a vehicle is on, the route comprising a destination. The vehicle DPS may determine a state of charge, in real time. The vehicle DPS may determine a charge depletion rate with respect to a drive history of the vehicle. The vehicle DPS may project whether the vehicle will be driven without sufficient buffer based on the state of charge, the charge depletion rate and the route, and initially, project that the vehicle will be driven with sufficient buffer to reach the destination, and in response, display routing information without including details of specific power-ups reachable from the route for so long as a projection that the vehicle will be driven with sufficient buffer.

### BACKGROUND

The present invention relates to a computer implemented method, data processing system, and computer program product for maintaining charge on a computer operating as part of an electrical vehicle even over paths with few or slow charging options.

Travelers who operate computer directed vehicles, can travel roads that are not near the best charging infrastructure. Electric cars rely on computers for a variety of functions. Among these functions are battery management; charge estimation; navigation; traction control; semi-autonomous road handling; accident avoidance; and the like. Moreover, computers in conventionally powered vehicles can loose owner preset information when a battery is removed and replaced. Clearly, given the many important functions of computers in vehicles today, maintaining a continuous power supply to the computer can be vital for even rudimentary driving functions.

Among the complexities felt by drivers of electric vehicles, is the heterogeneous mixture of refueling stations, where some stations are incompatible with some electric vehicles (EVs). Owners of large-capacity battery cars, such as the Tesla Model S, have access to a network of powerful chargers called superchargers. These chargers deliver charge at about five times the speed of more conventional slow chargers, explained below. Since to obtain an equivalent charge on a slow charger takes hours as compared to a supercharger, Tesla drivers frequently ignore those chargers. Moreover, even if such chargers could be displayed to a navigation screen, the slow chargers outnumber the superchargers 50 to 1—and tend to needlessly clutter the screen, to most Tesla driver's eyes

For example, an electric vehicle can reach a supercharger with a low state of charge. A typical supercharger delivers about 300 miles of range per hour of charging, at least during an initial phase of recharging. An alternative charge source, is the National Electrical Manufacturers Association (NEMA) 14-50 standard plug in North America. The NEMA 14-50, at about 50 amps, provides at least 10 times the current of a typical house-hold wall outlet. Nevertheless, the NEMA 14-50 can only refuel an electric vehicle (EV), such as a Model S, at about 30 miles of range per hour. Moreover, unlike a typical house-hold wall outlet, the NEMA 14-50 circuits are extremely rare, yet more plentiful than superchargers. Clearly, refueling for a day trip needing 300 miles of added/refueled range makes NEMA 14-50 refueling impractical, at least where superchargers are available.

Nevertheless, the NEMA 14-50, and other refueling standards that deliver fuel at less than a third of the supercharger, can be helpful in some scenarios. One problematic scenario, is refueling while en-route to a supercharger. A supercharger can be hypothetically reached by a model S that is at the maximum rated range of the Model S, provided, the terrain is flat, the car is fully maintained, the temperatures are better than spring-time temperatures, there is no head-wind, no precipitation falls and the driver drives at a conservative pace without sudden accelerations and decelerations, etc. This list might cover 95% of the factors that might impact a vehicle's range. As such, determining, with certainty, what is a distance an EV can reach, is difficult to know before and even during a trip, let alone anticipating and reacting to unexpected detours. Accordingly, when one or more factors, unexpectedly, become worse than anticipated, a driver can be surprised by a reduction in actual range of his vehicle, and the prospect that the vehicle becomes un-drivable and its core computing functions are reduced or eliminated.

Accordingly, the invention, described below, seeks to ameliorate this condition.

### SUMMARY

According to one embodiment of the present invention a vehicle data processing system (DPS) is provided for refueling a vehicle. The vehicle DPS may determine a route that a vehicle is on, the route comprising a destination. The vehicle DPS may determine a state of charge, in real time. The vehicle DPS may determine a charge depletion rate with respect to a drive history of the vehicle. The vehicle DPS may project whether the vehicle will be driven without sufficient buffer based on the state of charge, the charge depletion rate and the route, and initially, project that the vehicle will be driven with sufficient buffer to reach the destination, and in response, display routing information without including details of specific power-ups reachable from the route for so long as a projection that the vehicle will be driven with sufficient buffer.

According to another embodiment of the present invention, a vehicle DPS is provided to prompt options to recharge an electric vehicle. The vehicle DPS may receive an intended route. The vehicle DPS may determine at least one power-ups that meet a criteria with respect to the route. The vehicle DPS may determine an extended route that diverts from the intended route at a detour point along the intended route in order to reach the one among the at least one power-ups. The vehicle DPS may display with a display map of a segment of the intended route, a marker at the detour point relative to the intended route, wherein the marker is on a same side of the route as an initial turn is in relation to the detour point. The vehicle DPS may display, associated with the marker, an indication to indicate an additional distance necessary to reach both the power-up and the destination as compared to a distance that does not include the power-up.

According to another embodiment of the present invention, a vehicle DPS is provided to prompt options to recharge an electric vehicle. The vehicle DPS may receive an intended route comprising a destination. The vehicle DPS may display in a display, the intended route in a color that contrasts with landmark colors. The vehicle DPS may obtain coordinates from a mobile station. The vehicle DPS may determine progress along the intended route of the mobile station. The vehicle DPS may receive at the mobile station, from the electric vehicle, a state of charge. The vehicle DPS may determine a charge consumption rate of the electric vehicle. The vehicle DPS may determine a projected charge remaining at the destination. The vehicle DPS, in response to the projected charge remaining being unacceptably low in relation to a pre-set function of thresholds set by a user, may post a recharge option that meets a user criteria for adding travel time to a route that includes the recharge option and the destination as compared to the intended route. The vehicle DPS may obtain second coordinates from the mobile station inconsistent with the intended route, and consistent with a second route that can pass through the recharge option, and in response, extinguish the intended route from the display, and display a second route that incorporates the recharge option by showing the second route in the contrasting color.

According to another embodiment of the present invention, a vehicle DPS is provided to prompt options to recharge an electric vehicle. The vehicle DPS may receive an intended route and an intended destination. The vehicle DPS may determine a map display area. FIG. 8 The vehicle DPS may determine a segment of the intended route that symbolically extends through the map display area. The vehicle DPS may look up at least one power-up that corresponds to both the map display area and a limited distance from the segment, wherein the limited distance from the segment is added travel distance to include both the power-up and the intended destination in a modified route, and the added travel distance declines as a function of progress through the intended route. The vehicle DPS may display a marker for the at least one power-up, wherein the marker indicates a relative position of a turn to the power-up. The vehicle DPS may receive from the user, a request to notify the power-up, and in response, transmit a notification to the power-up with instructions to respond positively or negatively. The vehicle DPS may receive an agreement to provide charging from the power-up, and in response, report the agreement to the user.

### BRIEF DESCRIPTION OF THE DRAWINGS

FIG. 1 is a block diagram of a data processing system in accordance with an illustrative embodiment of the invention;

FIG. 2 is a diagram of a mapped diversion in accordance with an embodiment of the invention;

FIGS. 3A-3B shows two functions that operate as criteria for selecting a power-up for presentation in accordance with an embodiment of the invention;

FIG. 4 is a flowchart in accordance with an embodiment of the invention;

FIG. 5A-5C are a series of reports generated as a hypothetical car is driven along a hypothetical route in accordance with an embodiment of the invention;

FIG. 6 is an alternative manner for displaying reports concerning recharging options in accordance with an embodiment of the invention;

FIG. 7A-7B are alternative figures of a data processing system incorporated into an electric vehicle in accordance with an embodiment of the invention;

FIG. 8 illustrates a zone of maximum outliers for a set of power-ups that may be displayed by an illustrative embodiment of the invention;

FIG. 9 is a flowchart of steps to collect initial contacts from a power-up operator in accordance with an embodiment of the invention;

FIG. 10 is a block diagram of a server to host statistics concerning power-ups in accordance with an embodiment of the invention; and

FIG. 11 is a further display interface in accordance with an embodiment of the invention.

### DETAILED DESCRIPTION

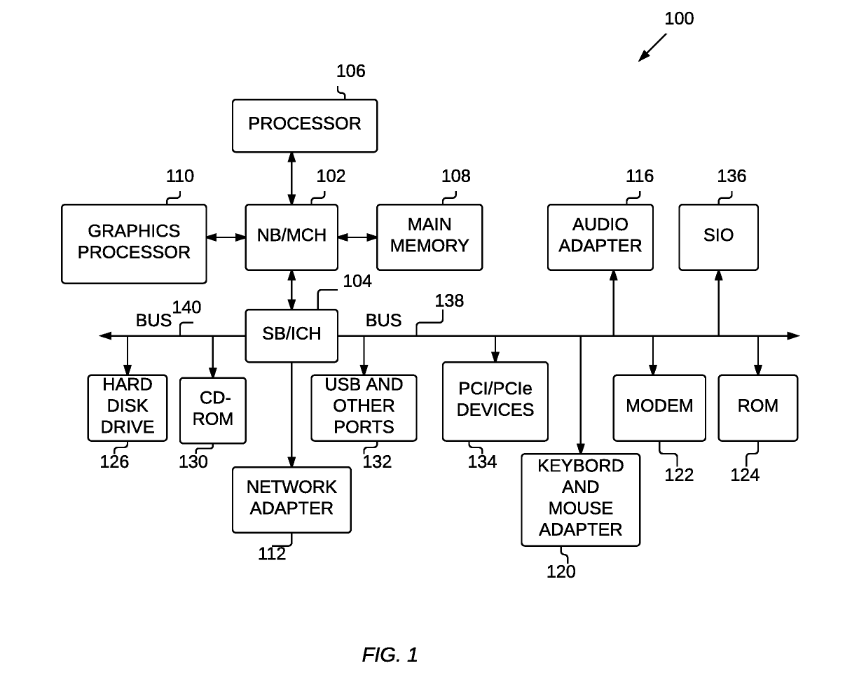

With reference now to the figures and in particular with reference to FIG. 1, a block diagram of a data processing system is shown in which aspects of an illustrative embodiment may be implemented. Data processing system 100 is an example of a computer, in which code or instructions implementing the processes of the present invention may be located. In the depicted example, data processing system 100 employs a hub architecture including a north bridge and memory controller hub (NB/MCH) 102 and a south bridge and input/output (I/O) controller hub (SB/ICH) 104. Processor 106, main memory 108, and graphics processor 110 connect to north bridge and memory controller hub 102. Graphics processor 110 may connect to the NB/MCH through an accelerated graphics port (AGP), for example.

In the depicted example, local area network (LAN) adapter 112 connects to south bridge and I/O controller hub 104 and audio adapter 116, keyboard and mouse adapter 120, modem 122, read only memory (ROM) 124, hard disk drive (HDD) 126, CD-ROM drive 130, universal serial bus (USB) ports and other communications ports 132, and PCI/PCIe devices 134 connect to south bridge and I/O controller hub 104 through bus 138 and bus 140. PCI/PCIe devices may include, for example, Ethernet adapters, add-in cards, and PC cards for notebook computers. PCI uses a card bus controller, while PCIe does not. ROM 124 may be, for example, a flash binary input/output system (BIOS). Hard disk drive 126 and CD-ROM drive 130 may use, for example, an integrated drive electronics (IDE) or serial advanced technology attachment (SATA) interface. A super I/O (SIO) device 136 may be connected to south bridge and I/O controller hub 104.

An operating system runs on processor 106, and coordinates and provides control of various components within data processing system 100 in FIG. 1. The operating system may be a commercially available operating system such as Microsoft® Windows® XP. Microsoft and Windows are trademarks of Microsoft Corporation in the United States, other countries, or both.

Instructions for the operating system, the object-oriented programming system, and applications or programs are located on computer readable tangible storage devices, such as hard disk drive 126, and may be loaded into main memory 108 for execution by processor 106. The processes of the embodiments can be performed by processor 106 using computer implemented instructions, which may be located in a memory such as, for example, main memory 108, read only memory 124, or in one or more peripheral devices.

Those of ordinary skill in the art will appreciate that the hardware in FIG. 1 may vary depending on the implementation. Other internal hardware or peripheral devices, such as flash memory, equivalent non-volatile memory, and the like, may be used in addition to or in place of the hardware depicted in FIG. 1. In addition, the processes of the illustrative embodiments may be applied to a multiprocessor data processing system.

In some illustrative examples, data processing system 100 may be a personal digital assistant (PDA), which is configured with flash memory to provide non-volatile memory for storing operating system files and/or user-generated data. A bus system may be comprised of one or more buses, such as a system bus, an I/O bus, and a PCI bus. Of course, the bus system may be implemented using any type of communications fabric or architecture that provides for a transfer of data between different components or devices attached to the fabric or architecture. A communication unit may include one or more devices used to transmit and receive data, such as a modem or a network adapter. A memory may be, for example, main memory 108 or a cache such as found in north bridge and memory controller hub 102. A processing unit may include one or more processors or CPUs. The depicted example in FIG. 1 is not meant to imply architectural limitations. For example, data processing system 100 also may be a tablet computer, laptop computer, or telephone device in addition to taking the form of a PDA.

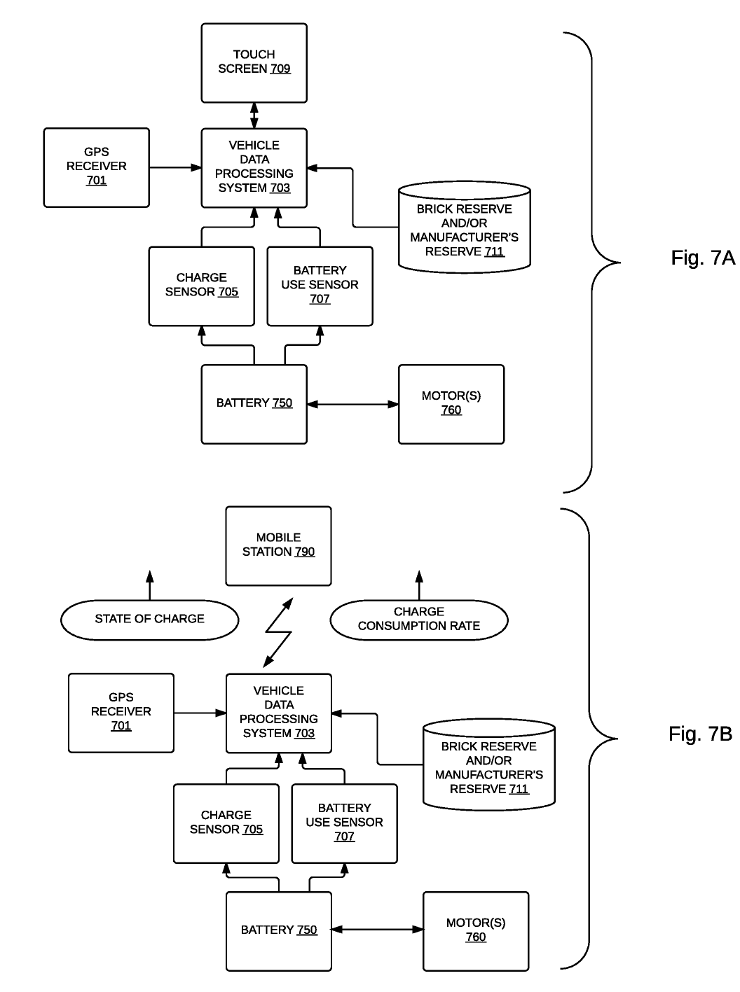

Particularly, where a computer serves as an integral part of a vehicle, a battery or other power sources are necessary to allow the computer to operate. In the context of a plug-in EV, the computer, necessarily, will need ‘shore power’ or a connection to an electricity infrastructure in order to maintain charge on a battery and thus the computer, beyond an initial charge of the battery. Examples of some battery configurations that can supply such charge to a vehicle data processing system appear at FIGS. 7A and 7B, below. Sustaining computer functions, then, depend on maintaining battery health and charge. As is well understood, a data processing system cannot operate without a suitable power supply.

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The description of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

One or more illustrative embodiments provides on-going real-time checks to see if recent charge consumption, and forecasted speeds over a remainder of a route will deplete the state of charge so much that the vehicle reaches an unacceptably low state of charge. These checks can be made with time to spare for the driver to react to the presented options. Such a reaction time or ‘heads up’ can be presented to a driver when the driver is still four miles away from a optional diversion from the intended route, so that the driver has time to assess the situation and the urgency. When such a suggested diversion is prepared, the navigation computer can return, from a geographic database, a power-up that is recessed from the route, and typically not visible from any U.S. interstate highway. As the database can be populated with RV parks (a form of power-up), that are not conveniently located, a criteria may be set ahead of time that establishes the maximum diversion, or most additional allowable miles to drive, as compared to the initial and intended route.

A power-up is a charging option that allows an intermediate rate of charge below that of a supercharger. In this context, a power-up is a slow charger, at least with respect to the fast charging of a supercharger. A range of power available at a power-up can be up to 88 kW capacity for a properly equipped car, such as the Tesla Model S 60 kWh sized battery and larger. The power-up includes NEMA 14-50 outlets suited for 50 amp service, a Tesla destination charger in 40 amp and 80 amp configurations, but not the supercharger. A supercharger, for reference, in good condition, up to 120 kW of power during an initial phase of a charging session for a depleted battery. A power-up provides current, sometimes after passing through a rectifier to become direct current (DC), at higher than a NEMA 5-20 rate, but lower than a supercharger rate. However, a more typical configuration of a power-up is an alternating current (AC) only supply of power.

The power-up is qualitatively different than the supercharger. The supercharger provides rapid recharge capability, but is more difficult to roll-out to all desirable locations, because of the extensive inverter and support equipment. In contrast, the power-up, by delivering less power than the supercharger, can be compact, and furthermore, may rely on inverters provided by the motorist to convert from alternating current (AC) to DC. As such, a power-up is markedly deficient as compared to any fueling station proximal to the destination. A fast charger is any charge delivering apparatus that cannot deliver over 88 kilowatts of power to a well maintained electric vehicle. A supercharger is any charger that can deliver 88 kW of power to a well maintained electric vehicle. A supercharger may solely deliver current to a vehicle using alternating current, except for communication functions. Necessarily, some older Tesla superchargers and superchargers that are faulty may be included as a fast charger, though the particular Tesla supercharger is an anomaly. In other words, the distinction between fast charger and a power-up, is that when in good working order, the charger can provide 88 kW of power or better. By ‘can’, a charger that is software limited or controllable from the charged vehicle to limit power below 88 kW remains a fast charger so long as at certain battery states of charge, and absent the user-entered charging limitation, 88 kW can be delivered to that vehicle. Additionally, a failure of one or more inverter modules in supercharger, can limit the charger below the 88 kW criteria. Nevertheless, despite a defect in the supercharger, which is controllable by the owner/controller of the supercharger, the defective charger can be treated as a supercharger or fast charger. A power-up can include chargers according to the Society of Automotive Engineers (SAE) J1772-2009 standard, CHAdeMO (also known as “CHArge de MOve”), NEMA 14-50 and the like.

Projected rated miles can be a factor in determining whether a diversion to a power-up is recommended. Projected rated miles is an estimate, given a car's driving history and intended route, of the rated miles expression of equivalent battery charge at the trip conclusion. In other words, a data processing system that applies a forecasting algorithm can determine an estimate whether projected rated miles is positive or negative, which is a good thing and a bad thing, respectively. A navigation system that uses an algorithm to get projected rated miles, attempts to use currently available data to predict what would happen, and in particular, what would the charge be at the conclusion of the trip once the destination is reached. Clearly, a data processing system that uses the projected rated miles algorithm will make many assumptions, and can be incorrect given that a driver may vary the speed of an EV at his whim. Nevertheless, the projected rated miles, when displayed and updated frequently to the driver, can offer a very helpful tool to determine if any intermediate charging is needed or an alternative strategy of driving is needed. Illustrative embodiments provide meaningful warnings and/or options to a driver when the projected rated miles is negative, or falls below a cushion or buffer that a user pre-sets as a preference for maintaining. A common step in many algorithms for projecting rated miles, is that the navigation system may determine a state of charge in the vehicle that is based, in part, on the energy consumed by the vehicle since a last recharge.

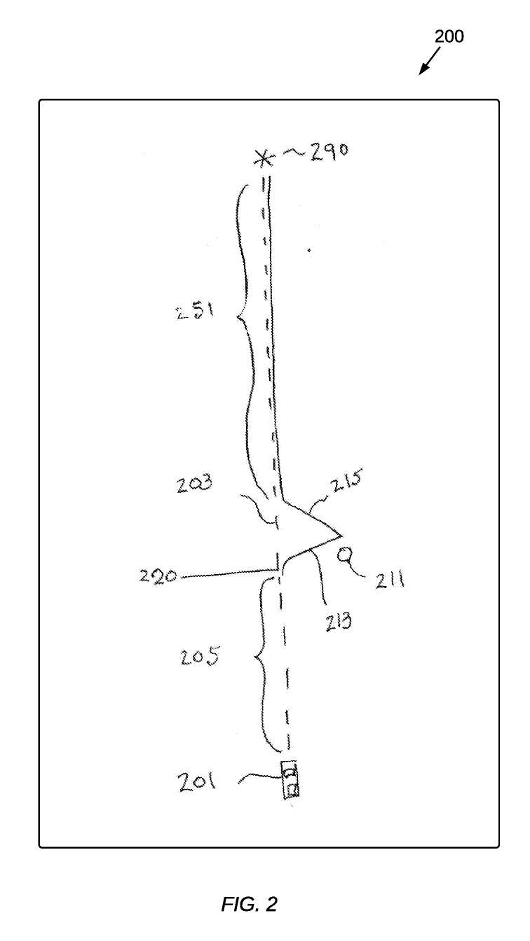

FIG. 2 is a diagram of a mapped diversion in accordance with an embodiment of the invention. An intended route 203 may be shown, at least in part, within a display 200. The display can be incorporated into a vehicle's dashboard or be within a portable computer, such as a smart phone. The navigation computer may display an intended route in a dynamic map that may be shrunken or zoomed as needed by owners, drivers and/or passengers. The navigation computer may be, for example, data processing system of FIG. 1. In a hypothetical example, an electric vehicle, such as a Tesla Model S has a rated range of 210 miles, which is a general rule of thumb for navigating the car. FIG. 2 can be displayed in a display of a data processing system, and may incorporate intersecting roads, city locations, water locations, road names and the like—not shown here, for sake of simplicity. An intended route can be displayed in a color that contrasts from any of the other features present in the displayed map. The displayed map may occupy a portion of a display, while other parts of a display are reserved for ancillary information, such as state of battery charge, outside temperature, status of environmental controls, and the like. Accordingly, the intended route and accompanying map details may occupy a rectangular or other shaped portion of the display, while not necessarily occupying the entire display.

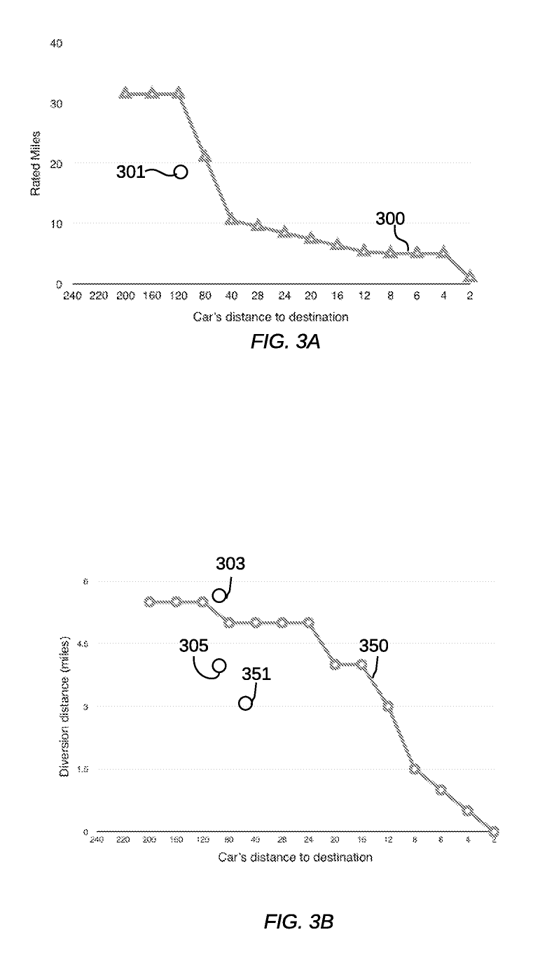

The map, as shown in the display, including the intended route, is limited in scope by the degree to which the user has selected to magnify or zoom the map. Accordingly, features that lie outside the scope set by the user, are not displayed until the orientation of the map allows such features to be displayed, or the zoom-level is enlarges the map's representative area to allow for such a feature to be displayed. A feature, is any road, waterway, conurbation, landmark and the like, that provides a user a context or simulation of a map. Nevertheless, a user may be able to limit the presentation of points of interest to those categories of features that the user wants to see. A point of interest is a business or attraction that can be a destination for a driver. Such points of interest can be marked with a distinct symbol or icon for that category. Accordingly, the navigation computer can display icons limited by the map scope and the categories that a user selects for display. Additionally, the user, who may be a driver, can also command the navigation computer to more narrowly restrict how icons are displayed to being less than the surface area of the displayed map features. In other words, the navigation computer, as explained below, can limit the display of icons concerning recharging options according to distances off the intended route that the recharging option is located. As such, the criteria, according to distance from a route, provides a kind of funnel, where early in the route, the distance is broad—and then later in the route, the distance is narrow. Thus, recharging options that exceed a distance limitation, but would otherwise be suited for display within the map, are excluded from display by the navigation computer. The distance limitation is explained further, below, with respect to FIG. 3B.

A location is recessed from a route, when the location, and any signs placed on its contiguous property, is not visible to a driver focused on driving. A location can be recessed for the reason that, even without vegetation, its structures and signs are too small in relation to the nearest segment of the route, for a driver to notice them, particularly, when the driver relies on peripheral vision. A location can be considered recessed from a route, when the road traffic from vehicles on the route, are not audible over birds chirping at the location. Accordingly, many, though not necessarily all, recreational vehicle parks (RV parks) are generally recessed from federal interstate highways. Necessarily, some road approaches an RV park. Accordingly an RV park may not be recessed with respect to some routes. Nevertheless, many RV parks may be within a zone of optional diversions from a route and still be so recessed from the route, as to be entirely overlooked by a driver, as a viable option to recharge. To the extent that an RV park hosts a power-up, that power-up is recessed from the route in the same way that the RV park can be recessed.

A current delivered to the motors or depleted from the battery may be measured, in real time during a drive in order to determine a consumption rate. The sampling period can be set to a distance or a time, such as 5 miles or 10 minutes. The course the car drives is not entirely shown in FIG. 2, rather car avatar 201 is shown above the traveled route, with the intended route 203 lying ahead and above the car avatar 201.

Charge consumption, is the current drawn off a main battery of an electric vehicle. The charge consumption can include major driving functions that draw current from the main battery during a pre-set sampling period. The pre-set sampling period may be measured in time or over a distance. The pre-set sampling period may result in current measurements since the beginning of a current drive. If a route is established while a vehicle is moving, then the sampling period may include operations of the vehicle covering a previous route as well as the current route. If, on the other hand, the vehicle was stopped for a substantial time (a stop), which may be a minute or more, then the sampling period may reset to whatever is smaller, a) the preset sampling period or b) the entire time/distance the vehicle has been driven since the stop. As such, the charge consumption can be an integration of current over the time that the vehicle traversed the sampling period, and divided by the distance the vehicle moved. The net result of a charge consumption calculation may result in a number having units of kWh/mile (kilowatt hours per mile). In SI units, the charge consumption may be in kWh/km.

A reaction space 205, which is a portion of the intended route, can be set to a pre-set distance or time. The reaction space can be a buffer of time and/or space that a navigation computer generates a diversion option to the driver. A navigation computer can generate the diversion option further ahead of time than the reaction space, and afford the driver more time to consider the option. For example, it can be useful for a driver to know four miles prior to a decision to take a diversion, so that passengers can be queried about their needs. Such a distance allows a driver to consider secondary options, such as easing off the accelerator. The reaction space may be a fixed distance selected by the driver. However, the reaction space may be automatically reduced in response to an approach to the intended destination that is shorter than the reaction space. Accordingly, once a vehicle gets to three miles of the destination, the reaction space may be reduced in half, for example, to two miles, or less, so that a last minute recharge can be made to bridge the final miles. In sum, the use of the reaction space may prevent the navigation computer from first displaying a suitable power-up when there is insufficient time for a driver to safely change lanes or otherwise maneuver to reach the first turn to the diversion option. The navigation computer may be set to use the reaction space to only show diversion options that were first announced at a distance greater than the reaction space from the car's earlier positions.

The driver may slow down if more time to react is necessary. Alternatively, a driver may enter, to a navigation computer, a preset value that is a longer preset distance or time as the reaction space needed for decision-making. In response to criteria being right for displaying options, the illustrative embodiments can show multiple power-ups on a map such that more distant diversion points are shown. Once a driver gets within the reaction space from a diversion point, the navigation computer can persist in showing the power-up option throughout the reaction space, even as a distance to the diversion point shrinks. This hysteresis can continue even if the driver modifies his driving efficiency, and the criteria to initially display the power-up fails to be met. Persistence can be maintained until the driver passes a diversion point.

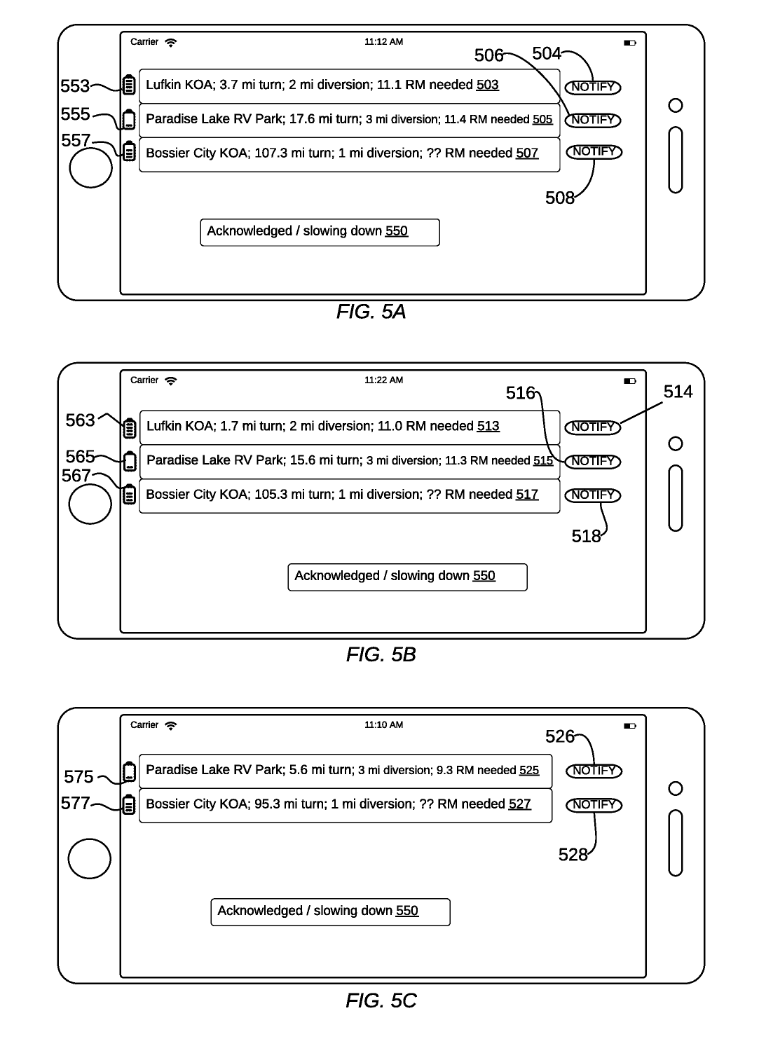

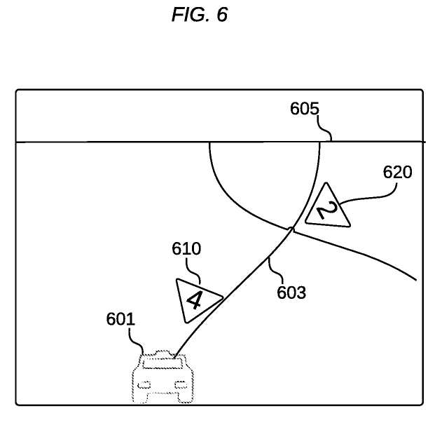

The power-up 211 can be recessed from the intended route 203. As such, it might not be visible to even attentive passengers as the car makes a closest approach. Additionally, signage can be non-existent for the power-up, at least along the route. An option may present itself in graphic form, as per FIG. 6, or in words, as per FIGS. 5A-5C. Graphically, the diversion is symbolically shown with two legs: 1) the approach leg 213; and 2) the return leg 215. Each of these legs, when added to the route remainder 251, can become part of the new route. The sum of approach leg, return leg and route remainder minus the intended route remaining from diversion point 220 is the amount of the diversion. A diversion point is a place where an alternative route diverges from the intended route. The diversion point can be at a location on a shortest road route from a vehicle's current location to a power-up. In other words, the diversion distance associated between the intended route and power-up 211, is the additional distance to incorporate the power-up into a new route to the destination 290, at least with respect to the initially planned route. The actual diversion distance can be estimated, given, that there is an unknown driving distance among multiple charging options present at a power up, such as an RV park. This diversion distance must not exceed a threshold set for the corresponding segment of the intended route. The thresholds may diminish as the car gets closer to the destination, as described further in FIG. 3B below.

FIGS. 3A and 3B show two functions that operate as criteria for selecting a power-up for presentation in accordance with an embodiment of the invention. The x-axis of the functions is the distance remaining on the route for the vehicle to travel to the destination. The distance remaining under conditions identical to those used in the EPA tests will yield driving efficiencies that make the remaining distance to travel be the same as the range remaining under range calculations that use a simplistic steady charge required per mile, also known as rated miles (RM). However, given that the vehicle, in real life, will not be recreating laboratory or test track conditions, charge remaining will vary somewhat from a charge estimated remaining in the battery, and expressed in rated miles.

A state of charge is an estimated charge accessible for driving functions or a usable capacity. A usable capacity of a battery of the vehicle is that amount of charge that the battery provides for driving functions. The amount of charge can be limited by the manufacturer for various purposes. For example, the usable capacity of a battery may exclude a safety margin of minimal charge for the battery as set by the manufacturer. The safety margin can be a residual amount of charge that prevents the battery from swelling, forming unwanted crystals or any other unwanted degradation. As another example, the usable capacity of a battery may exclude portions of charge that are reserved by the manufacturer for over-the-air upgrades to the car or other sales and marketing after-sales support.

The SOC may not account for specialized battery levels intended to maintain health of the battery or set aside for commercial purposes to be inaccessible for driving functions. Driving functions comprise operating the car's lights, displays and environmental controls, as well as the more typical accelerating, regenerating and other convenience features. The SOC can be expressed in rated miles, the hypothetical distance a car can be driven on a unit of charge under hypothetical conditions. The SOC can be expressed in units of charge, such as kilowatt hours. Alternatively, the SOC can be expressed in percentage of the battery charge usable for driving functions, namely from 0-100%. FIG. 3A uses a domain in units of a car's distance to its destination. As a car discharges a battery during travel, the charge begins, potentially, at 200 rated miles provided the battery is charged to a full level (approximate range under Environmental Protection Agency (EPA) conditions using a old and degraded Tesla Model S 60 battery). A charge of 0 rated miles is undesirable because a car may be programmed to halt driving in order to maintain a small unit of charge, that is, the safety margin used to prevent battery failure/damage. This small unit of charge can prevent or reduce the chance of a car being ‘bricked’ or the battery damaged. Electric vehicle manufacturers can allow a driver to select reports of charge to be in ‘rated miles’ or in kilowatt hours, depending on the driver's preference. Accordingly, the 0 rated miles displayed to the driver, or other zero charge display, is the charge level that occurs when this manufacturer's safety level is reached. This condition, is what a feature of the illustrative embodiments is intended to avoid. Any protracted period of a vehicle being in this state can slowly deplete the battery until the computer of the vehicle cannot operate.

A 100% charge can vary during the lifetime of a car, as the battery can degrade and loose charging capacity. Charge levels reported to the user, as mentioned, can be in terms of watts, percentages of capacity or rated miles. Alternatively, a manufacturer can unlock additional battery capacity through software updates or authorizations, thus freeing formerly reserved portions of the battery charge for use by the driver. Accordingly, a 100% charge, as reported to the driver, may be less than or greater than the ‘as new’ charge capacity, and can be recalibrated from time to time. A manufacturer may make the unlockable portion of battery charge at either the high end, around 90% and more of actual battery capacity, or the low end, around 10% of actual battery capacity. Accordingly, the point in actual battery charge at which driving functions end can be somewhat higher than necessary for pure battery integrity/longevity reasons, particularly when the manufacturer decides to lock out, access to battery charge at the bottom of a battery's charge range. In sum, the manufacturer selects the preset level of battery charge that is not to be used for driving functions, and results in potential stranding of motorists that fail to head warnings from a navigation computer.

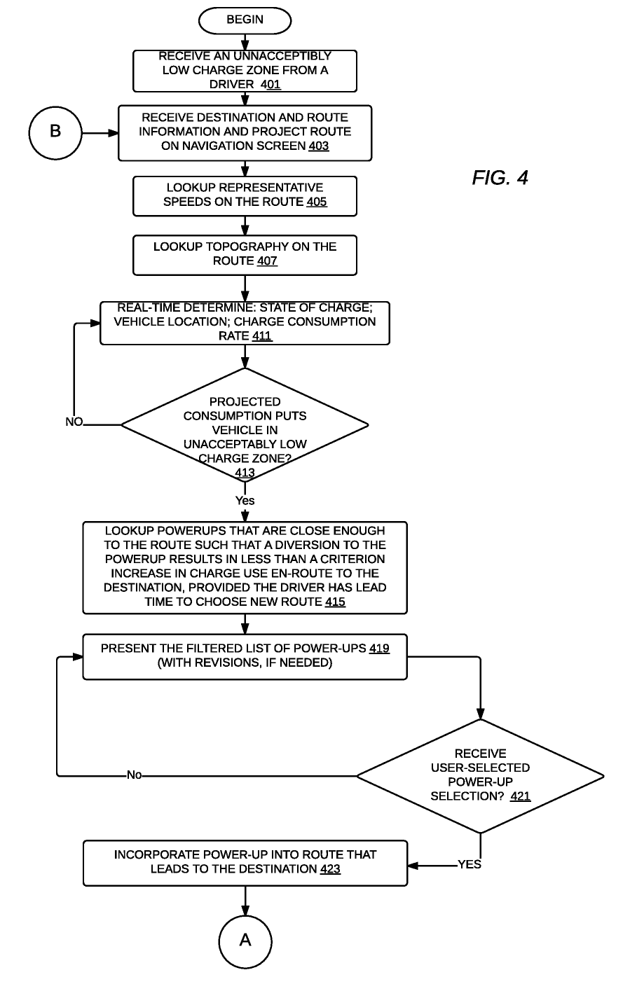

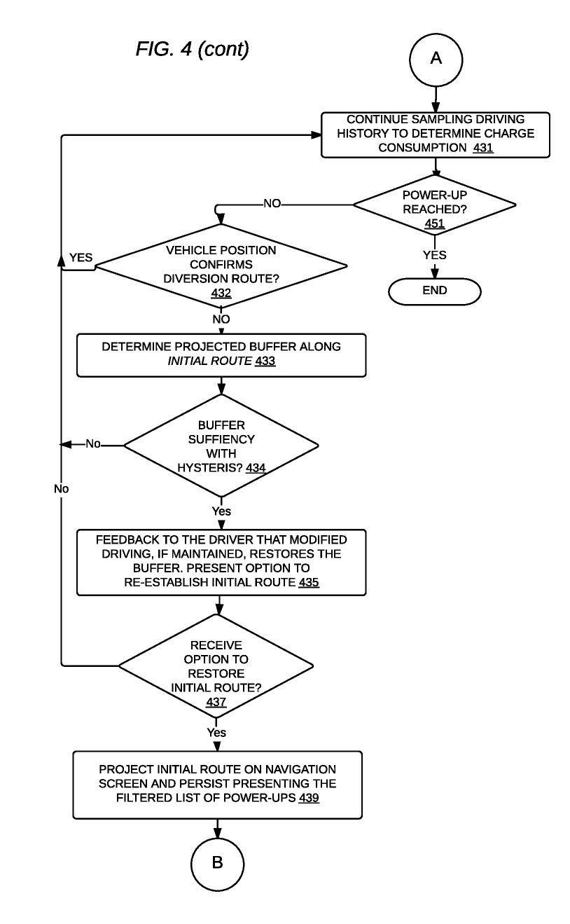

Unacceptably low state of charge 300 is a criteria the navigation computer uses to determine if a diversion should be presented, assuming a database includes power-ups that meet other criteria, such as FIG. 3B. The ‘0 miles’ charge at the far right of the X-axes in FIGS. 3A and 3B is the charge at which the manufacturer prohibits further driving functions, or at least the adding of momentum through the drive units of the vehicle. Again, this charge, at which a car becomes stranded, is determined by the interplay between safety considerations for the battery, and upgradeability that a manufacturer wants to offer. This criterion or threshold is checked at FIG. 4 step 413, below. The levels of charge, can be measured in rated miles. The rated miles are hypothetical at least for a particular car. However, the rated mile may be a distance a new model drives the ‘mile’ distance based on testing by a government authority or according to a government authority's testing methods. In the United States, the government authority is the Environmental Protection Agency (EPA), and the EPA, in coordination with auto manufacturers assigns rated ranges to a car model. In the case of EVs, the rated range corresponds to a distance that the available battery capacity can be used to drive the tested car model.

In other words, FIG. 3A depicts, for a given distance remaining in the intended route (x-axis) v. projected rated miles available at trip-end on the intended route (y-axis), what level of projected rated miles, at its destination, must the car sink below for options to present?

FIG. 3A shows SOC 301 as a corresponding projection of rated miles (RM) expected at trip ending v. the car's actual remaining distance to travel (X-axis). The data point 301 indicates a car's SOC at 110 rated miles remaining in the route. The navigation computer determines the projected rated range depicted at 301 to be at 18 rated based on information available this far into the trip. However, FIG. 3A shows the corresponding unacceptably low state of charge 300 for this phase of the trip is 26 miles of rated range. The function 300 may be pre-set by the manufacturer and/or modified by the driver, preferably before beginning the trip. The function can describe the driver's comfort level with a safety buffer predicted at different times during the trip.

At this time, the navigation computer may identify power-ups, recessed from the route, that are to be presented to the driver. The navigation computer may refer to FIG. 3B to filter power-ups from a database of slow chargers. Two power-ups may be in the database. FIG. 3B shows distant power-up 303 may lie above a function of maximum diversion distance 350 that corresponds to this phase of the trip. This function can be preset by the manufacturer and/or modified by the driver as an expression of how comfortable the driver feels about straying from the intended route to find alternate power sources. The phase of the trip, is on the X-axis in terms of miles remaining to reach the destination. The maximum diversion distance, is the maximum added driving distance the user prefers to drive to add any proposed power-up to the route, with its distance measured along the Y-axis. The maximum diversion distance may taper to a smaller distance, as the scale of the remaining trip shrinks to the right of FIG. 3B. The function can be modified to suit a driver's preferences.

Accordingly, distant power-up 303 fails to meet the criteria for maximum diversion distance. However, power-up A 305 may be below the maximum diversion distance. However, power-up A 305 may be too near, at approximately 108 miles from the destination, such that it cannot be presented to the driver to allow a pre-set reaction time or distance before committing to a diversion at a diversion point. In other words, power-up A might include an initial turn off the intended route within a mile of the car's current position, while the driver prefers diversion notifications of at least four miles before an initial diversion off the intended route. Power-up B 351 may meet both of these criteria. First, it is within the maximum diversion distance. Second, it can be 25 miles away from the vehicle and have an initial turn off or diversion point greater than a preset reaction time/distance, which can be set to four miles. Diversion options behind the driver may not be considered.

FIG. 4 is a flowchart in accordance with an embodiment of the invention. Initially, the navigation computer can receive an unacceptably low charge (ULC) zone from a driver 401. For a simple setting for new drivers, the driver may set a distance of 35 miles, thereby replacing the function of FIG. 3A with a flat function over all distances to the destination. The driver may also enter to the navigation computer, a preferred reaction time or distance to initial turn to a diversion option. The unacceptably low charge zone may be a simple function for a constant mileage for all states of charge, e.g., 35 miles and below is unacceptably low charge. Alternatively, a driver may set a more complex unacceptably low charge zone, such as unacceptably low charge zone 300 of FIG. 3A. In sum, the unacceptably low charge (ULC) conceptually represents a buffer of charge that provides a measure of security to a driver, that the driver can use to cope with unexpected occurrences on the drive, and still be able to reach a destination or an optional intermediate charging point. One might draw comparisons to the ULC with a ‘low fuel’ light in more conventional internal combustion cars. However, unlike the ‘low fuel’ light, the ULC can be tailored to reflect varying needs for a buffer throughout the different stages of a trip. Some drivers might not care to have any interruptions concerning refueling options during a first 40 miles driven after giving their vehicle a full 100% charge of say, an estimated 200 miles of range. Accordingly, those drivers might set the function to show that 0 rated miles of charge and above for SOCs between 200 and 160 rated miles to the destination. In other words, only when 0% or less charge is projected to be in the battery, upon reaching the destination, should any report be generated. And only projected charges of less than 0%, relative to the maximum battery capacity, are expected to generate reports/options about alternative power-ups. A driver may even set a preference to make some thresholds a negative projected rated range, particularly when the driver can expect herself to drive very efficiently early in a trip.

The navigation computer may also receive driver preferences for maximum diversion distance to populate the function of FIG. 3B at step 401. Both the user-inputs of thresholds for projected rated range and maximum diversion distance can be set either before a trip or during a trip.

Next, the navigation computer may receive destination and route information (step 403). The driver may enter a destination by using a position looked up from a driver's contacts database, a location selected from a points of interest database shown in the displayed map, a location clicked on in a displayed map, etc. Next the navigation computer may lookup representative speeds along segments of a selected route (step 405). These speeds may factor into a calculation of energy consumption, which can be modified by driver's exceeding or otherwise altering her speeds while en route. Further, the navigation computer may lookup topography on the route (step 407). Climbing hills may consume energy, and will be a factor in an initial energy consumption set before forward travel occurs. In other words, a navigation computer will allot more energy consumption per unit of hill climbing than for a similar descent on a hill operating at similar speeds.

The driver may begin driving. The navigation computer may real-time determine a state of charge, vehicle location and charge consumption rate (step 411). As the driver makes progress into the route, the navigation computer may make revisions to fuel consumption that may be controlled by factors and unavailable to the navigation computer's consumption algorithm, for example, wind speeds, and a driver's relative aggression or passivity on the driving controls. Each of these factors will contribute, in real-time to both the state of charge and the fuel burn rate, and thus allow the navigation computer to establish a projected charge consumption rate, in real-time.

The driving history, either contributing from the current drive, or contributing from the current drive and at least a portion of a previous drive, can provide some guidance concerning the charge consumption, and accordingly, may be an input to the consumption algorithm that projects consumption through to the destination. The projected consumption may result in a projected buffer remaining at the end of the trip that is compared to the user's preset values of buffer, e.g., as shown in FIG. 3A. A hypothetical duration of driving history to sample for use in predicting future driver behavior along the route can be five minutes of driving. Similarly, the driving history can be measured over a set distance, for example, five miles. A driver, if warned concerning driving efficiency, may slow down and take other steps over a fraction of that sampling period. Revisions to the consumption algorithm output after such behavior modifications can result in navigation computer revising projected buffer(s) to satisfactory levels that exceed buffer requirements in FIG. 3A.

Next, the navigation computer may determine whether projected consumption puts the vehicle in an unacceptably low charge zone (step 413). Under conservative driving and charging conditions, the result will be that the projected consumption is not unacceptably low, and the navigation computer may continue to re-execute steps 411 and 413 until the car is parked and/or turned off.

However, a positive result to step 413 may cause the navigation computer to lookup power-ups that are close enough to the route such that a diversion to the power-up results in less than a criterion increase in charge use en-route to the destination (step 415). As mentioned, the limit to charge use, may be expressed in rated miles. For example, the navigation computer may determine that when the car at stage 301 or about 120 miles from destination, that power up 351 is well within the FIG. 3B diversion distance criteria. This step 415 may also exclude a power-up that is too close for a proper lead time or reaction time/space for the driver, even thought that power-up is within the diversion distance limits set by the driver. In other words, when the preset reaction time/space is not satisfied, the navigation computer does not display the otherwise acceptable power-up.

Next, the navigation computer may present a filtered list of power-ups (step 419). A nearest of the power-ups may be shown as a contrasting colored line splitting from the intended route markings on the displayed navigation map. Alternatively, there can be an additional power-up option displayed by the navigation computer further down the road—and sometimes, there may be five or more such power-ups. Presenting or posting of such options can be either in visual form, e.g. to a map showing route progress, or by audible description from a computer synthesized voice. FIGS. 5A-5C can be another option for presenting and/or posting specific power-up details to a driver. If, however, a FIG. 6 display is used, then only power-ups that fit within the map may be displayed, at its current zoom level. In other words, if the displayed map covers a town, that is rectangular, then only those power-ups present in that town will be symbolically represented in the navigation displayed map. However, two classes of power-ups can be excluded: a) those power-ups that are recessed beyond the criteria set, for example, by the function in FIG. 3B. and, b) those power-ups that are too close to the driver when the driver needs to make his decision. In other words, the second class of power-ups are either so close on the map that displaying them to the driver amounts to a surprise that can be too hard to adjust course to reach.

Next, the navigation computer may receive a user-selected power-up selection (step 421). In response to the user selection, the navigation computer may incorporate the selected power-up into a route that leads to the destination (step 423). Next, the navigation computer may continue sampling driving history to determine a charge consumption (step 431). Next, the navigation computer may determine if the power-up is reached (step 451). If the power-up is reached by the electric vehicle, the navigation computer may terminate execution.

However, if the power-up is not reached, the navigation computer may determine if the electric vehicle has navigated to a position on a route that can reach the power-up (step 432). In other words, the driver, by navigating the vehicle through an off-ramp or a turn, signals her intention to take an optional power-up. If the navigation computer confirms the vehicle is on the second route, the navigation computer may repeat step 431.

On the other hand, if the vehicle is determined to not be on the diversion route, the navigation computer may determine a projected buffer along the initial route (step 433). Next, the navigation computer determines whether the projected consumption based on the current driving history and the initial route is sufficient to exceed the minimum threshold (ULC) provided that the current driving history shows efficiencies that persist for a hysteresis period (step 434). In other words, it is not helpful to go back and forth between urging a driver takes the diversion option and indicating that current behavior allows ignoring the diversion option. Such a situation can develop for a driver that alternates rapidly between accelerating and coasting.

Provided the result in step 434 is positive, the navigation computer may feedback to the driver that a recent medication in driving history/behavior, can, if maintained, restore the projected buffer after driving the intended route (step 435). The navigation computer may additionally present an option to the driver to re-establish the initial route. However, a negative result at step 434 can return processing to 431.

Next, the navigation computer may determine whether it receives an option to re-establish the initial route (step 437). If not, the navigation computer may resume processing at step 431. Otherwise, the navigation computer may project the initial route on a navigation screen (display) and persist presenting the filtered list of power-ups (step 439). Processing may continue on to step 403.

Alternatively, the driver may not make a selection, and ignore, even temporarily, the options presented. The options can be presented in order of nearest to furthest, that meet the criteria. As each of the initial turn offs are passed by the car, the navigation computer may remove that power-up from the top of the list (or other form of presentation), and raise the farther power-ups (descriptions) higher in the list. Other details listed, such as miles to the initial diversion turn may be dynamically updated to reflect driving progress. Similarly, the navigation computer may update each option description to include a display of miles calculated as necessary to be added, in the form of charge, to the car in order to restore the car to a) just above the unacceptably low state or b) some margin miles above the current unacceptably low state.

Further, the driver always has the option (displayed or not), to slow down, ease the wind resistance that plagues driving efficiency, and recover charge in a manner that causes future samplings, for example, at step 411, to determine a more charge efficient driving style has been adopted, or at least reflect greater reserved charge in the projected consumption step 413. As such, an initial proposed set of options, may, be iterative revised to show an improved charge/fuel situation. See FIGS. 5A-5C, below.

FIG. 5A-5C are a series of reports generated as a vehicle is driven along a hypothetical route in accordance with an embodiment of the invention. FIG. 5A may show a status of reports at a point partially into a trip, while FIG. 5B shows after further progress into the trip and FIG. 5C shows a time even further into the trip, when options may be diminishing. Initially three RV parks are shown or reported by navigation computer in FIG. 5A. Lufkin KOA 503 is nearest, Paradise Lake RV Park 505 is farther, while Bossier City KOA 507 is the farthest. Lufkin KOA 503 can initially be presented a few minutes prior to FIG. 5A, before a reaction time/space in front of the vehicle has shrunken to under a reaction space of 4 miles. Bossier City KOA 507, at 107.3 miles until the initial turn or diversion point, may be so far away that a meaningful amount of charge, expressed in range miles (RM) is unable to be predicted. Accordingly, for distant options, a place holder of “??” may indicate the uncertain amount of charge that may be needed as the vehicle approaches that diversion option.

FIG. 5B shows each of these sites closer, with the mileage and projections being updated to reflect diminished charge, and revised projections of remaining charge at trip completion. Accordingly, Lufkin KOA 513 is shown nearer than in FIG. 5A. Updates are correspondingly made to 515 and 517.

Finally, FIG. 5C shows a situation where Lufkin KOA is either passed, or the diversion point to the Lufkin KOA is now behind the driver's current position. Accordingly, the list of options is reduced, and only Paradise Lake RV Park 525 presented, with the next option, Bossier City KOA additionally presented 527. FIGS. 5A-5C are shown within the display of a mobile station, such as mobile station 790, of FIG. 7B below. Nevertheless, the navigation can present the same details within a display of the electric vehicle itself, such as shown, for example, in FIG. 7A.

In each of FIGS. 5A-5C, the driver may select a route to take by using a touch screen and simply touching the surface at the desired option. In a mobile station based hardware embodiment (FIG. 7B, below), the mobile station may follow-up with an updated route, depending on the specific power up selected. Alternatively, the driver may touch a displayed button of “Acknowledged/slowing down” 550. Such an input may restore the display of a guidance map for a set duration before the navigation computer reinstates a refreshed set of options. As such, between each of FIG. 5A, FIG. 5B and FIG. 5C, a mobile station may show progress along an intended route in a map until an alternative power-up is selected. A user who selects a power-up may trigger the navigation computer to execute steps 421 and 423 in the flowchart of FIG. 4.

Each option, presented in FIGS. 5A-5C may allow the user to elect to notify the business, owner or controller of the power-up to inquire about the availability of charging? For example, each option may have user-selected ‘notify’ buttons 504, 506 and 508. In response to receiving the user entry of, for example, button 504, the navigation computer may transmit a message to a published contact of the power-up. The contact can be a telephone number, an email address, a twitter account, or the like. The navigation computer may, in at least one language of the business operator, request confirmation of availability of charging apparatuses for near-term use by the electric vehicle that the navigation computer operates. The notification may include details such as, type and color of the EV, current distance and estimated time of arrival of the EV. The notification may provide two or more responses by the business: 1) yes, near-term availability exists; 2) no, near term availability is not available; or 3) it is uncertain if an apparatus will be available. Accordingly, three steps can give a driver some high-level of assurance that the business has sufficient capacity, good functioning units and is equipped to handle an incoming EV. First, the navigation computer provides a button for the driver to elect to notify the business. Second, the navigation computer receives the user's selection of the button, which may alternatively be via voice command. Third, the navigation computer, sends the notification, soliciting the business for some form of acknowledgement. Fourth, the navigation computer may receive the response of the business, that at least in the near term, arrangements can be made for charging.

FIG. 6 can be an alternative manner for displaying reports concerning recharging options in accordance with an embodiment of the invention. The contents of FIG. 6 may be displayed to a dashboard of an electric vehicle. FIG. 6 may be a display of 3D view of the path in front of a navigated vehicle. In contrast, FIG. 2 is a 2D view looking down on the vehicle and route ahead. As a display for navigation may be limited in how many symbols can be added before it becomes unwieldy and crowded, symbols may be kept to a bare minimum to enhance a driver's situational awareness of recharging options. A driver may want a continuous stream of recharging options visible to a navigation screen as presented within a vehicle dashboard. In some instances, the driver might want such options to be mentioned even without any risks or stress of recharging need. Accordingly, a sparse display might include three details: 1) a location of a first turn from the currently navigated route that can get a driver promptly to the power-up; 2) an indication of which way the initial turn or ramp will take the driver, as he might explore the option to reach a power-up; 3) an indication of what the magnitude of recharging need might be given driving history, SOC and current position, and including any sufficiency criteria that might exist at the time/place of the turn-off.

Accordingly, FIG. 6 relies on markers, rather than messages, to provide some idea to the driver of the added mileage a diversion may require and even some concept of what a density of options might be through the route traveled. Further, a driver may pre-set criteria to focus the presentation of markers to only those power-ups that meet the criteria. Criteria can include a) type of charging apparatus; b) presence of public bathrooms at or near the power-up; c) food available nearby the power-up; d) distance, along a most direct route, from power-up to destination. There are many types of charging apparatus, and more may be invented as the electric vehicle industry matures. Some types require special adapters to operate with the driven vehicle. Other types might be known to provide slower charge rates or have reliability issues. Accordingly, a database might be as follows, in Table 1, from which a driver might set preferred criteria.

TABLE 1

| | Remains to | | | | |
|---|---|---|---|---|---|
| | destination | Bathroom | Hookup | Food | Diversion |
| Hank's Creek Park | 123 | Y | NEMA 14-50 | N | 20 |
| Lufkin KOA | 114 | Y | NEMA 14-50 | Y | 1 |
| Paradise Lake RV Park | 99.5 | N | NEMA 14-50 | N | 1 |
| Whispering Pines RV Park | 78.1 | Y | J1772 20 kW | Y | 6 |
| Bossier City KOA | 10.3 | Y | NEMA 14-50 | Y | 2 |

Thus, a user may indicate a preference to see only power-ups that are NEMA 14-50 hookups and diversion distances of fewer than 4 miles. The result can be: Lufkin KOA; Paradise Lake RV Park and Bossier City KOA according to that criteria based on data present in Table 1. The markers can be superimposed on a display that places the car avatar 601 at the base of the display and an intended route 603 extending from the car avatar to a simulated horizon 605. Features on the map may generally be updated real-time to scroll down from the vicinity of the horizon 605 to the car avatar, optionally showing foreshortening of objects that are more distant. Marker 610 can, within this context, show details of a) driving distance between the car and the initial turn off the route; b) a direction the initial turn or ramp will be, as indicated by the side of the intended route 603 the marker is placed; and c) the cost, in, for example, miles, that the diversion will take as compared to proceeding directly along the route. A fourth piece of data may be displayed by applying color or changing the shape of the marker, where the changed color and/or shape corresponds to one of three urgency factors: 1) the degree of actual projected SOC upon arrival at destination, e.g., −8%, . . . , 0%, . . . 20% of driver-accessible battery charge; 2) the degree of deficit in projected SOC versus a threshold ULC for that position; 3) the degree of miles equivalent of charge necessary to restore the car to a minimal charge level above the ULC to complete the trip. Accordingly, marker 620 may denote a diversion point that is more distant from the vehicle than marker 610. Marker 620, by the ‘2’ presented therein, can indicate an approximate 2 mile diversion distance to include a more distant power-up into a revised route. Further, marker 620, by its presence to the right of route 603 can indicate that the driver needs to look towards a future revision in the route to highlight and otherwise signal a turn right of the initial planned route. A driver can accept a power up through the use of a touch sensitive display, navigation cursor or even through a voice interaction with the navigation computer.

A navigation computer may use a color-coding scheme to show, in green, the number or the marker frame, if the power-up is unnecessary to maintain the charge buffer denoted in ULC values, as shown, e.g., in FIG. 3. The navigation computer may use a yellow color to show that the power-up is needed to restore a deficit of less than half of the ULC buffer. A red coloring may be applied to show that the power-up is needed to restore a deficit of more than half of the ULC buffer or that the deficit exceeds the ULC buffer entirely, and no miles of charge are expected at the destination, if the destination can be reached at all. Rather than color, an alternative scheme can use triangle, square and octagonal markers to show a progression to a lowered projected charge level. Furthermore, a particularly urgent situation may be one where the projected charge level is expected to reach zero, or at least a recent calculation of projected charge level determined a zero or lower charge at trip completion.

Many alternative display methods are possible, including hovering a pointer over the markers 610, 620 to get more details, especially, with more precision, concerning amounts of charge to count on requiring once the power-up is reached. As such, hovering over the marker can cause the navigation computer to respond with a pop-up box containing the information, the added information being presented to a reserved area at the margin of the display; a voice enunciation of the added information through a speaker in the vehicle, and the like. The information can be as detailed, or even more detailed than that in, e.g., FIG. 5A 501. The triggering of such responses may be alternatively be performed by touching a touch-sensitive screen at the marker, or by pressing a button to rotate through navigation features, including the one or more markers. This last method may signal which among the markers is the selected marker, by providing a halo around the marker, changing colors in the marker or otherwise highlighting the marker with a screen effect.

A marker is valid for so long as a car has not passed an initial turn that links the power-up into the trip. As the final few seconds of a marker being valid occur, the navigation computer may signal graphically and/or announce audibly, that an optional recharge turn is approaching. The navigation computer may flash the marker several times in time for a driver to gracefully slow the vehicle and enter a turn. Nevertheless, a driver may choose to proceed along the intended route. In response, the navigation computer may extinguish the marker from the displayed map.

Accordingly, this last illustrative embodiment can provide a minimal, and yet frequently continuous indication that options are available, though often off the beaten path. At the same time, this last embodiment doesn't overwhelm the driver with excessive clutter on the screen.

FIG. 7A-7B are alternative figures of a data processing system incorporated into an electric vehicle in accordance with an embodiment of the invention. Vehicle data processing system (DPS) 703 may collect information from charge sensor 705 and battery use sensor 707. Vehicle DPS may be arranged according to data processing system 100 of FIG. 1. Vehicle DPS 703 may receive location information from Global Positioning System (GPS) receiver 701, as well as from a speedometer. Limits as to allowable charges to use in vehicle functions may be stored to a database. The database can be stored to non-volatile storage and contain a brick reserve and/or a manufacturer's reserve 711. Charge sensor 705 may be coupled to the battery to measure the state of the battery 750. For example, a state of charge may be inferred of the battery or battery system by measuring one or more cell's voltage drop in the battery system. Additionally, battery use sensor 707 may measure current added to a battery as well as current delivered to the subsystems of the vehicle. As such, data returned to the vehicle DPS 703 can be used to estimate charge remaining in the battery, for example, in terms of rated miles, as well as efficiency in converting that charge into miles traveled through one or more motors 760.

Touch screen 709 may be one form of user interface that allows a user to see useful diversions as well as entering and navigating routes. Additionally, mouse control and steering wheel buttons can be added to the vehicle DPS 703 to assist in selecting routing options.

FIG. 7B is an alternative hardware configuration that relies on a mobile station, such as, for example, a smart phone. Mobile station 790 may access state of charge 780 and charge consumption rate 790 via a wireless channel established with a vehicle data processing system 703. Mobile station 790 may be designed according to data processing system 100 of FIG. 1. In some cases, the connection from mobile station 790 to vehicle DPS 703 may be made through an intermediary, such as a server on the internet. User interfaces of the mobile station can be as described in FIGS. 5A-5C. The hardware embodiment of FIG. 7B can be helpful in instances where a vehicle lacks human occupants or drivers present in the vehicle.

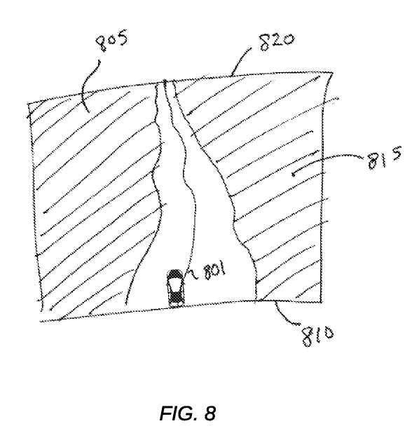

FIG. 8 illustrates a zone of maximum outliers for a set of power-ups that may be displayed by an illustrative embodiment of the invention. Using an intended route 801 as a reference, a map may be displayed to rectangular portion 800 of a display. In other words, the navigation computer may determine a map display area, which can include determining which real-world features can be fit, symbolically, within the rectangular portion 800. The view depicts a car icon, to the bottom 810 and a direction of travel at the top 820 in a top-down view of the map. Left exclusion zone 805 is the map area that is far too recessed for even a straight-line departure from the intended route to be within the diversion distance limit described, for example, at FIG. 3B above. Right exclusion zone 815 is the map area that is far too recessed for even a straight-line departure from the intended route to be within the diversion distance limit described, for example, at FIG. 3B above. The exclusion zones are determined in relation to a segment of the intended route 850. Distant power-up 303 of FIG. 3B would be excluded for the reason that if it were displayed in its relative location within the map, it would fall in one of the excluded zones. Areas outside the left and right exclusion zones may then be used to display the diversion options location, relative to the driver's position and intended route, provided reaction space and other criteria, if set, are met. In other words, the un-shaded portion of FIG. 8 are not beyond the maximum extent for outliers, and are thus candidates for being displayed when the ULC condition is met. As can be seen, the un-shaded portions are broad at earlier phases of the trip, and narrow as the intended route gets nearer the intended destination. Any power-ups displayed, then, correspond to both the map display area, and the limited distance from the segment of the intended route, which gradually shrinks further into the route.

A further embodiment can include a computer implemented method to prompt options to recharge an electric vehicle, the method comprising: receiving an intended route comprising a destination; displaying in a display, the intended route in a color that contrasts with landmark colors; obtaining coordinates from a mobile station; determining progress along the intended route of the mobile station; receiving at the mobile station, from the electric vehicle, a state of charge; determining a charge consumption rate of the electric vehicle; determining a projected charge remaining at the destination; in response to the projected charge remaining being unacceptably low in relation to a pre-set function of thresholds set by a user, posting a recharge option that meets a user criteria for adding travel time to a route that includes the recharge option and the destination as compared to the intended route; and obtaining second coordinates from the mobile station inconsistent with the intended route, and consistent with a second route that can pass through the recharge option, and in response, extinguishing the intended route from the display, and displaying the second route that incorporates the recharge option by showing the second route in the contrasting color.

Posting the recharge option can include displaying a name of an operator of the recharge option and a distance added to include the recharge option between a current vehicle position and the destination. Determining projected charge remaining comprises iteratively determining projected charge consumption for legs along the remainder of the route.

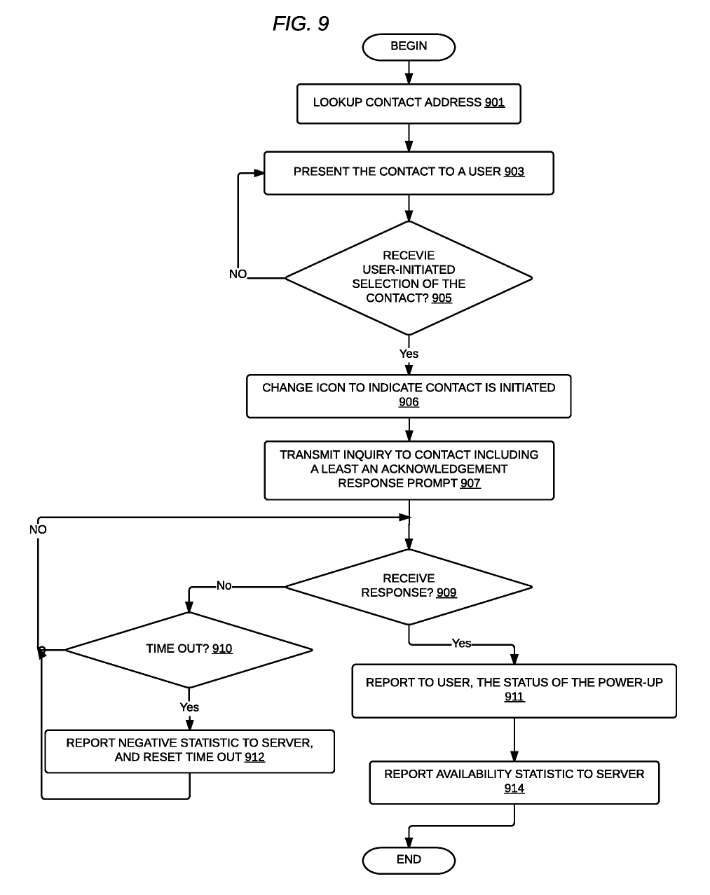

FIG. 9 is a flowchart of steps to collect initial contacts from a power-up operator in accordance with an embodiment of the invention. Initially, the navigation computer may look-up a contact for details concerning any contact addresses, such as, an associated email, telephone number, text address, Facebook page for the power-up (step 901). A contact address, is any address that allows two-way communication to an entity, either human or machine. The communication mode may be simplex, half-duplex or full-duplex. Accordingly, any initial contact may either be replied to, or ignored. In the example, below, email is the communication channel.

Next, the navigation computer may present the contact to the user, for example, by name (step 903). The presenting can be according to any of FIGS. 5A-5C. As such, the contacts presented may dynamically evolve as a user's car proceeds along the intended route. Next the navigation computer may determine whether it received, from a user, a selection of the contact (step 905). If no contact choice is received, the navigation computer may repeat checking for contact selections.

However, if a user does select a contact, the navigation computer may revise the icon to indicate ‘notified’ (step 906). Alternatively, the navigation computer may replace the icon, such as icon 504 with information symbolic of the state of the communication. A stop light motif or icon may be used in place of ‘notified’, where a signal that the inquiry was dispatched might be illuminating the yellow light.

Next, the navigation computer may transmit an inquiry to the contact address (step 907). A suitable email or text inquiry might be: “A Tesla will be passing through your area soon. The driver asks if you continue to offer charging services for electric vehicles? Please respond to this communication with a ‘yes’ or a ‘no’.” A substitute alternative embodiment may involve the navigation making a telephone call to a contact telephone number associated with the power-up. Such a call can be made using an additional cellular transceiver added to the navigation computer. An instruction of the call may be, “Press ‘1’ if you are able to supply a charge to an electric car in the next hour.” Correspondingly, a human user may respond to the call by pressing a ‘1’ button on a telephone handset, thereby generating a dual-tone multi-frequency (DTMF) tone corresponding to ‘1’. The navigation computer may interpret the 1 DTMF tone as a power-up agreement to provide charging from the power-up.

Step 907 may also include an estimate of the arrival time for the car, if road speeds are reasonably constant. Step 907 and 906 may be reversed in order.

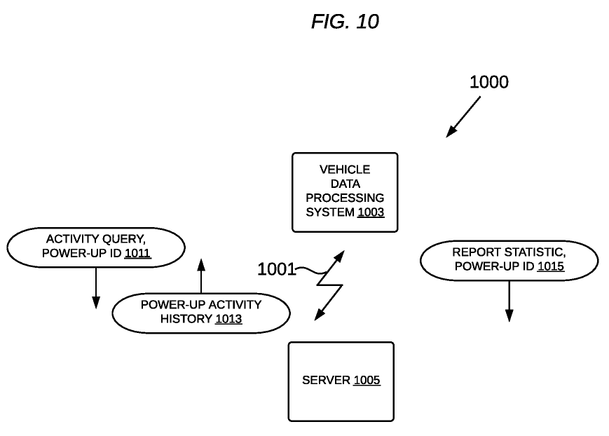

Next, the navigation computer may determine whether it received a response (step 909). A response is determined as received if the address that was used in step 907 for sending, is now the address from which the current communication is received. Navigation computer may determine if a time-out has occurred (step 910). If no time-out occurs, step 909 is repeated. If the time-out occurs before a response is received from the contact, the navigation computer may report a negative statistic to a server and reset a time-out (step 912). The server is explained further in FIG. 10, below. Each report given at steps 912 and 914 may include an identifier of the power-up. Further waiting for the response may occur while tracking the time-out at steps 909 and 910.

However, if a response is received, the navigation computer may report the status to the user (step 911). The navigation computer may determine a positive response, for example, when the response uses the word ‘yes’, or in telephone embodiments, responds with ‘1’ DTMF. The navigation may determine a negative response, for example, when the response uses the word ‘no’. Any other response may be an indeterminate response.

Reporting the status can be by display and/or through a speech synthesized response. For example, in displaying a positive response, the navigation computer may change a stop light motif to show a green light illuminated. Conversely, the navigation computer may, in response to receiving a negative response, change a stop light motif to show a red light illuminated. The tri-state stop light motif may replace the ‘notify’ icons in FIGS. 5A-C, above, and dynamically report to the user current status information about each power-up. Next, the navigation computer may report an availability statistic to the server (step 914). The availability statistic can be ‘yes’ corresponding to a positive response. The availability statistic can be ‘no’ corresponding to a negative response. Other responses may be indeterminate, and may be reported as such to the server. Processing may terminate thereafter.

A user may initiate several inquiries in this way, to confirm the possibility of charging with as many power-ups as are displayed. For example, the user may select all the ‘notify’ buttons 514, 516, 518 in FIG. 5B, to get more complete information concerning the route ahead. FIG. 5B also permits later selection of ‘notify’ buttons 526, 528.

FIG. 10 is a block diagram of a server to host statistics concerning power-ups in accordance with an embodiment of the invention. Server 1005 may be a data processing system, for example, data processing system 100 of FIG. 1. Server 1005 may be in communication with vehicle data processing system 1003 over a channel 1001 and one or more wired networks. Statistics are collected by the server to establish a reliability and/or responsiveness measure for each power-up. As can happen, a power-up may be out of service, removed, closed for the season, or unusable for a number of reasons. In order to account for these situations, negative and positive statistics can be reported by plural vehicle data processing systems, for example, as described at FIG. 9. A useful ratio may be the number of positive reports for a power-up divided by the sum of all reports returned to the server concerning the power-up. An availability measure is a measure of a proportion of a sum of positive reports concerning a power-up, divided by other report types.

Server 1005 then receives plural statistics 1015 from the vehicles. The statistics may be stored and retrieved on request from the vehicles. For example, vehicle may make activity query including a power-up identifier to the server (step 1011). The server may look-up the power-up, and obtain activity history. For example, the server may report that 100% of all vehicle notifications to the power-up were responded to with a positive response within a time limit set by the time-out. In another situation, the server may report that 25% of all notifications to the power-up were responded to with a positive response. In each case, the server may report the percentage and optionally, the power-up identifier to the vehicle data processing system. Additionally, the server may report the sum of all notifications that the server has concerning a power-up.

The vehicle may receive such a report, and augment, when sufficient data is available, a display concerning the power-up's status, for example, at FIG. 5A-5C. In each case in FIG. 5A sufficient data exists for each of the three options shown. For example, the Lufkin KOA may respond positively 100% of the time. Accordingly, a most positive icon, in the form of a filled battery 553 may be displayed alongside the Lufkin KOA report. In contrast, the Paradise Lake RV Park may only respond 25% of the time positively. In which case, the navigation computer may report a near-empty battery icon 555. Additionally, half filled battery icon 557 may signal that Bossier City KOA has an intermediate level of responsiveness from the operator of the power-up. Similar icons may be present at other times, 563, 565, 567, 575, and 577. Accordingly, when sufficient data is available, a user may have a sense of the chances that a working site is present at the power-up.

A number of statistical refinements may occur on server 1005. For example, older data may be discarded after 20 or some other pre-set number of notification data points are stored for a power-up. As such, a first-in-first-out queue can be formed. Data that is too old is no longer part of the percentage calculation. That way, if a power-up comes under new management, its reputation can quickly bounce-back after the old data is discarded 1013.

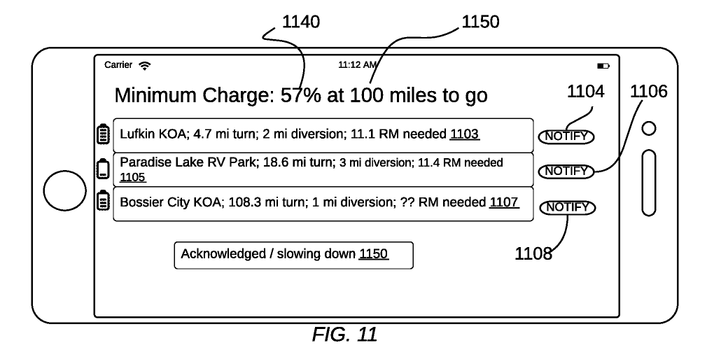

FIG. 11 is a further display interface in accordance with an embodiment of the invention. The navigation computer may be arranged as per FIG. 7B implementing a GPS receiver within the mobile station 790. Accordingly, the mobile station may receive an intended route and an intended destination. Next, the mobile station may receive a state of charge profile such that the state of charge corresponds to miles to a destination. The charge profile may form a general use criteria for use showing a suggested minimal charge for the safe completion of a trip. The charge can be a number shown as a percentage of the usable charge in a battery as it relates to the miles remaining to be traveled.

Next, the mobile station may receive progress of its progress in the intended route. By virtue of the mobile station being within a vehicle, the mobile station may track the progress of the vehicle's progress. The mobile station may, based on the intended route, calculate the current miles to the intended destination, in reliance on the GPS receiver data. The mobile station may look-up a corresponding state of charge from the profile, in response to the current miles, and then display the state of charge criteria from the state of charge profile 1140, as well as current miles 1150, in this case 100 miles to go.

Next, the mobile station may determine, for a power-up that satisfies a nearness criteria, whether the vehicle is approaching a decision point. The decision point is a distance between a vehicle position and a diversion point to get to a power-up. The decision point can be a fixed distance pre-set by a user, such as, for example, 5 miles prior to arriving at the diversion point. As explained above, the reaction space can be this fixed distance, and allows the driver some time to respond to the changing charge situation. The displayed state of charge criteria 1140 may be compared by the driver to any values reported by a vehicle display concurrently with the mobile station. Accordingly, the driver may have a preset criteria to know when an established line is crossed into territory of charge below the minimum charge displayed.

Optionally, in response to the decision point being approached, the mobile station can report details of the power up, for example details 1103, 1105 and 1107. Additionally, active buttons to notify the respective power-ups 1104, 1106, and 1108 can be provided. Much like FIGS. 5A-5C, the values in each power-up may be updated to reflect progress as reported by GPS. Similarly, progress in both the miles to a destination and a corresponding minimal charge criteria can be updated in tandem with the miles to the destination.

The illustrative embodiments may permit a driver to receive episodic warnings of low charge coupled with concise diversion options that would allow the driver to boost charge reserves. The warnings/options can occur in response to increasing charge consumption as compared to earlier stages in the trip. The navigation computer may ease warnings, at least by showing a declining recommended charge or fuel intake, in response to a repeated sampling of driving efficiency and route progress. Accordingly, a driver may proceed more at ease into a zone that the car's rated miles cannot bridge, or can bridge, but without margins for safety. Further, by avoiding stranding a vehicle at low levels of battery charge, the vehicle's computer(s) may continue to operate without interruption. This feature can be helpful in instances where a vehicle lacks human occupants. A side effect of the feedback can include more rapid progress to the target supercharger as compared to a prior approach of immediately proceeding to an out-of-the-way supercharger so as to obtain sufficient charge to reach the destination supercharger. Another side effect is that the electricity consumed by the vehicle to reach the target supercharger can be lower than the alternative two supercharger itinerary used in the absence of the embodiments. Accordingly, less fossil fuels may be required for the trip.

The present invention may be a system, a method, and/or a computer program product. The computer program product may include a computer readable storage device (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories, which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or computer readable tangible storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for refueling a vehicle, the computer implemented method comprising:
determining a route that a vehicle is on, the route comprising a destination;
determining a state of charge, in real time;
determining a first charge depletion rate with respect to a drive history of the vehicle;
projecting whether the vehicle will be driven without sufficient buffer based on the state of charge, the first charge depletion rate and the route, and initially, projecting that the vehicle will be driven with sufficient buffer to reach the destination, and in response, displaying routing information without including details of specific power-ups reachable from the route for so long as a projection that the vehicle will be driven with sufficient buffer.

2. The computer implemented method of claim 1, further comprising:
second determining a second state of charge, in real time;
second determining a second charge depletion rate after second determining the first charge depletion rate;
second projecting whether the vehicle will be driven without sufficient buffer based on the second state of charge, the second charge depletion rate and the route, and projecting that the vehicle will be driven without sufficient buffer, and in response, reporting a report about at least two diversion power-ups, wherein the report comprises at least one selected from the group consisting of: identifying information; miles before a diversion road is available; and charge estimated necessary to reach the destination with sufficient buffer, based at least on the second state of charge and second charge depletion rate, wherein the power-up is markedly deficient as compared to any charging station proximal to the destination.

3. The computer implemented method of claim 2, wherein reporting the report about at least two diversion power-ups comprises excluding at least one power-up that is geographically corresponding an area of a displayed map, but is recessed beyond the intended route by a criteria distance.

4. The computer implemented method of claim 2, wherein reporting the report about at least two diversion power-ups comprises excluding at least one power up, that is geographically corresponding an area of a displayed map, and is not recessed beyond the intended route by the criteria distance, but has a corresponding diversion point that is less than a reaction space from a current position of the vehicle.

5. The computer implemented method of claim 1, wherein the state of charge is based in part on energy consumed since a last recharge.

6. The computer implemented method of claim 1, wherein the state of charge or an estimate of charge left in relation to a usable capacity of a battery of the vehicle.

7. The computer implemented method of claim 1, wherein the diversion power-up is a fifty amp charging facility and recessed from the route.

8. A computer program product for refueling a vehicle, the computer program product comprising: a computer readable storage medium having computer readable program code embodied therewith, the computer readable program code comprising:
computer readable program code configured to determine a route that a vehicle is on, the route comprising a destination;
determine a state of charge, in real time;
computer readable program code configured to determine a first charge depletion rate with respect to a drive history of the vehicle;
computer readable program code configured to project whether the vehicle will be driven without sufficient buffer based on the state of charge, the first charge depletion rate and the route, and initially, project that the vehicle will be driven with sufficient buffer to reach the destination, and in response, computer readable program code configured to display routing information without including details of specific power-ups reachable from the route for so long as a projection that the vehicle will be driven with sufficient buffer.

9. The computer program product of claim 8, further comprising:
computer readable program code configured to second determine a second state of charge, in real time;
computer readable program code configured to second determine a second charge depletion rate after second determine the first charge depletion rate;
computer readable program code configured to second project whether the vehicle will be driven without sufficient buffer based on the second state of charge, the second charge depletion rate and the route, and project that the vehicle will be driven without sufficient buffer, and in response, computer readable program code configured to report a report about at least two diversion power-ups, wherein the report comprises at least one selected from the group consisting of: identifying information; miles before a diversion road is available; and charge estimated necessary to reach the destination with sufficient buffer, based at least on the second state of charge and second charge depletion rate, wherein the power-up is markedly deficient as compared to any charging station proximal to the destination.

10. The computer program product of claim 9, wherein computer readable program code configured to report the report about at least two diversion power-ups comprises computer readable program code configured to exclude at least one power-up that is geographically corresponding an area of a displayed map, but is recessed beyond the intended route by a criteria distance.

11. The computer program product of claim 9, wherein computer readable program code configured to report the report about at least two diversion power-ups comprises computer readable program code configured to exclude at least one power up, that is geographically corresponding an area of a displayed map, and is not recessed beyond the intended route by the criteria distance, but has a corresponding diversion point that is less than a reaction space from a current position of the vehicle.

12. The computer program product of claim 8, wherein a drive history is during a current excursion on the route.

13. The computer program product of claim 8, wherein a drive history comprises a data collected from a distance the vehicle has covered since a manufacturing date.

14. The computer program product of claim 8, wherein computer readable program code configured to project whether the vehicle will be driven without sufficient buffer based on the state of charge, the second charge depletion rate and the route further comprises computer readable program code configured to display at least one road segment of the route on a display of the vehicle.

15. The computer program product of claim 8, wherein computer readable program code configured to determine the state of charge comprises computer readable program code configured to receive charge data from at least one sensor attached to the vehicle; and wherein computer readable program code configured to determine second charge depletion rate comprises computer readable program code configured to receive battery use data from at least one sensor attached to the vehicle.

16. The computer program product of claim 8, wherein a power-up is any charge delivering apparatus that cannot deliver over 88 kilowatts of power.

17. The computer program product of claim 8, wherein a power-up is any charge delivering apparatus that delivers alternating current to charge a battery of the vehicle.

18. A computer implemented method to prompt options to recharge an electric vehicle, the computer implemented method comprising:
receiving an intended route and a destination;
determining at least one power-ups that meet a criteria with respect to the route, wherein the criteria is that a route modification that includes the power-up and ends at the destination adds a distance compared to an intended route remainder distance such that the distance added is below a function as related to remainder in the intended route;
determining an extended route that diverts from the intended route at a detour point along the intended route in order to reach the one among the at least one power-ups;
displaying with a display map of a segment of the intended route, a marker at the detour point relative to the intended route, wherein the marker is on a same side of the route as an initial turn is in relation to the detour point; and
displaying, associated with the marker, a number to indicate the distance.

19. The computer implemented method of claim 18, further comprising:
determining, iteratively, that a vehicle will reach an unacceptably low state of charge based on vehicle location, driving history, and state of charge, and in response,
change a display feature of the marker to indicate a diminished state of charge

20. The computer implemented method of claim 19, further comprising:
determining, iteratively, that a vehicle will reach an unacceptably low state of charge based on vehicle location, driving history, and state of charge, and in response,
change a color of the marker to a color associated with a diminished state of charge.
